(19) United States
(12) Patent Application Publication
(10) Pub. No.: US 2025/0269321 A1
(43) Pub. Date: Aug. 28, 2025

(54) MULTI-STAGE SCRUBBER SYSTEM INCLUDING A VACUUM PUMP

(71) Applicant: StreamTech, Inc., Houston, TX (US)

(72) Inventor: Frank Attar, Houston, TX (US)

(21) Appl. No.: 19/060,700

(22) Filed: Feb. 23, 2025

Related U.S. Application Data
(60) Provisional application No. 63/557,031, filed on Feb. 23, 2024.

(51) Int. Cl. B01D 53/18; B01D 53/14

(52) U.S. Cl. CPC B01D 53/18; B01D 53/1406; B01D 53/1487; B01D 2221/08; B01D 2252/10; B01D 2257/708; B01D 2258/06

(57) ABSTRACT

A scrubber system includes a liquid ring vacuum pump, a water tank and a surfactant column. The pump has a vacuum inlet port, an exhaust outlet port, and a water supply port. The water tank has an inlet port coupled to the exhaust outlet port of the pump, a water return port connected to the water supply port of the pump for supplying water to the pump, and a first overhead vapor port. In addition, the surfactant column has an inlet port connected to the overhead vapor port of the water tank and a second overhead vapor port. The pump draws air containing volatile organic compounds from a vapor space in a main tank that contains wastewater and pushes the air through the water tank, surfactant column and, optionally, a further carbon column. Volatile organic compounds are removed from the air before release into the atmosphere.

### BACKGROUND

The present disclosure relates to scrubber systems for removing volatile organic compounds (VOCs) from air.

### BACKGROUND OF THE RELATED ART

Organic compounds are chemical compounds that contain carbon, specifically including compounds that include a carbon-hydrogen bond and/or a carbon-carbon bond. There are millions of known organic compounds, but alkanes such as methane and ethane are well-known examples.

Volatile organic compounds (VOCs) are those organic compounds that have a high vapor pressure at room temperature. The high vapor pressure of a particular organic compound, also known as volatility, relates to the amount of the organic compound that will be present in the air surrounding a sample of the organic compound.

Volatile organic compounds may cause a detectible odor in the air and some volatile organic compounds may be hazardous to human health and/or the environment. Accordingly, it can be beneficial to contain volatile organic compounds and even remove volatile organic compounds from air in various situations.

### BRIEF SUMMARY

Some embodiments provide a scrubber system comprising a liquid ring vacuum pump, a water tank and a surfactant column. The liquid ring vacuum pump has a vacuum inlet port, an exhaust outlet port, and a water supply port. The water tank has an inlet port coupled to the exhaust outlet port of the liquid ring vacuum pump, a water return port connected to the water supply port of the liquid ring vacuum pump for supplying water to the liquid ring vacuum pump, and a first overhead vapor port. In addition, the surfactant column has an inlet port connected to the overhead vapor port of the water tank and a second overhead vapor port.

Some embodiments provide a method comprising: drawing air containing volatile organic compounds from a vapor space in a main tank of a vacuum truck that contains wastewater using a liquid ring vacuum pump that is fluidically connected to a vapor space port in the main tank; supplying water from a water tank containing a body of water to the liquid ring vacuum pump to form a water seal that supports operation of the liquid ring vacuum pump; pushing the air and a portion of the water through a discharge port of the liquid ring vacuum pump and into a lower portion of the water tank, wherein the air rises through the body of water to a vapor space in the water tank; directing the air that is in the vapor space of the water tank into a lower portion of a surfactant column containing a surfactant solution, wherein the air rises through the surfactant solution to a vapor space in the surfactant column, and wherein the air is scrubbed to remove the volatile organic compounds from the air as the air rises through the body of water in the water tank and as the air rises through the surfactant solution in the surfactant column; and releasing the scrubbed air into the atmosphere.

### BRIEF DESCRIPTION OF THE SEVERAL VIEWS OF THE DRAWINGS

FIG. 1 is a process diagram of a scrubber system according to some embodiments.

FIG. 2 is a perspective view of a vacuum truck according to some embodiments.

### DETAILED DESCRIPTION

Some embodiments provide a scrubber system comprising a liquid ring vacuum pump, a water tank and a surfactant column. The liquid ring vacuum pump has a vacuum inlet port, an exhaust outlet port, and a water supply port. The water tank has an inlet port coupled to the exhaust outlet port of the liquid ring vacuum pump, a water return port connected to the water supply port of the liquid ring vacuum pump for supplying water to the liquid ring vacuum pump, and a first overhead vapor port. In addition, the surfactant column has an inlet port connected to the overhead vapor port of the water tank and a second overhead vapor port.

The scrubber system receives air containing volatile organic compounds at the vacuum inlet port of the liquid ring vacuum pump and provides the technical benefit of reducing an amount of volatile organic compounds (VOCs) remaining in the air when the air is released into the atmosphere. The liquid ring vacuum pump is the safest and most environmentally friendly type of vacuum pump to operate in applications that may handle gases that are combustible. Embodiments of the scrubber system may be operated to achieve combustible gas concentrations in the air below a lower explosive limit (LEL). The scrubber system provides the additional technical benefit of including a water tank that serves the purposes of supplying water to the liquid ring vacuum pump, providing for the separation of water and air coming out of the liquid ring vacuum pump, and forming a first stage scrubber for removing the volatile organic compounds from the air provided to the vacuum inlet port of the liquid ring vacuum pump.

A liquid ring vacuum pump is a type of rotary positive displacement pump used to generate vacuum by means of a rotating impeller within a cylindrical casing. The pump operates by partially filling the casing with a sealing liquid, such as water, which forms a moving ring due to centrifugal force as the impeller rotates. This liquid ring creates a series of crescent-shaped cavities between the impeller blades. These cavities expand and contract during rotation, drawing in and compressing the gas. The gas is then expelled through an outlet, while the sealing liquid recirculates, maintaining the vacuum. The pump's simple design, minimal moving parts, and ability to handle wet and contaminated gases make it ideal for the present wastewater handling embodiments.

In some embodiments, the scrubber system may further include a carbon column having an inlet port connected to the overhead vapor port of the surfactant tank and an outlet port that opens to the atmosphere. Accordingly, the water tank may provide a first stage scrubber, the surfactant column may provide a second stage scrubber, and the carbon column may provide a third stage scrubber or cleaner. The carbon column includes a dry carbon bed that absorbs volatile organic compounds and, therefore, operates in a different manner than the water tank and surfactant scrubber. However, all three stages may remove volatile organic compounds and release air that is cleaner than when the air entered the stage.

In some embodiments, second stage scrubber and/or the third stage scrubber or cleaner may be duplicated to form a stage having a second similar column in series with a first column. In one example, the second stage scrubber may include a first surfactant column and a second surfactant column in series. The overhead vapor port of the water tank (first stage scrubber) is connected to the inlet port of the first surfactant column, the overhead vapor port of the first surfactant column is connected to an inlet port to the second surfactant column, and the overhead vapor port of the second surfactant column is connected to the inlet port of the carbon column (third stage scrubber). In another example, the third stage scrubber may include a first carbon column and a second carbon column in series. The overhead vapor port of the surfactant column (the final column of the second stage scrubber) is connected to the inlet port of the first carbon column, the overhead vapor port of the first carbon column is connected to an inlet port of the second carbon column, and the overhead vapor port of the second carbon column is open to the atmosphere. Accordingly, the embodiments include a scrubber system with one or more surfactant columns and one or more carbon columns, where each of the columns are connected in series with the one or more surfactant columns upstream of the one or more carbon columns. The one or more surfactant columns and/or the one or more carbon columns may or may not be identical in construction and/or identical in composition of the scrubbing fluid or dry bed material. In one option, a first surfactant column may contain a first surfactant solution, and a second surfactant column may contain a second surfactant solution. For example, the first surfactant may have a greater capacity for removing volatile organic compounds from the air while the second surfactant may have a stronger affinity for the volatile organic compounds. In another option, the first carbon column may contain the same carbon bedding material as contained in the second carbon column, but the carbon in the second carbon column may be fresher (i.e., has a greater remaining capacity for absorption of volatile organic compounds) than the carbon in the first carbon column. These and other variations may be implemented in accordance with the embodiments herein.

In some embodiments, the scrubber system may further include a vacuum truck having a main tank for receiving wastewater, wherein the main tank has an overhead vapor port coupled to the vacuum inlet port of the liquid ring vacuum pump. A vacuum truck may obtain wastewater from various sources. For example, the wastewater may be domestic waste, industrial waste, commercial waste, agricultural waste and/or surface runoff. Domestic waste may include fecal matter or other components that can release volatile organic compounds into the air around the domestic waste. The scrubber systems described herein are designed to scrub the air to remove some or all of the volatile organic compounds from the air prior to releasing the air into the atmosphere.

In some embodiments, the liquid ring vacuum pump, water tank, surfactant column and carbon column are mounted on the vacuum truck. Conveniently, this configuration allows the vacuum truck to move from site to site collecting wastewater and/or delivering wastewater to a treatment facility and always have the scrubber system available to clean the air. For example, the scrubber system may be operated continuously, periodically or on demand. It is a technical benefit of the scrubber system embodiments that a mobile scrubber system may be utilized to reduce or eliminate volatile organic compound emissions wherever the vacuum truck may be in operation. It should be appreciated that a truck-mounted scrubber system must have compact dimensions and operate efficiently and reliably.

In some embodiments, the wastewater within the main tank releases volatile organic compounds into a vapor space in the main tank. The liquid ring vacuum pump may then draw air and the volatile organic compounds from the vapor space through the overhead vapor port of the main tank into the vacuum inlet port of the liquid ring vacuum pump. Accordingly, the liquid ring vacuum pump forces the air and volatile organic compounds through the surfactant tank and the carbon column in series before the air is released to the atmosphere.

In some embodiments, the water tank and the surfactant tank each scrub the air to remove volatile organic compounds from the air as the air passes through the water tank and the surfactant tank. Similarly, the carbon column absorbs volatile organic compounds from the air prior to releasing the air into the atmosphere. With continued use, the capacity of a body of water in the water tank, a surfactant solution in the surfactant column and a bed of activated carbon in the carbon column to scrub or absorb volatile organic compounds may be exceeded. Accordingly, the water, surfactant solution and/or the carbon bed may need to be replaced.

In some embodiments, the water tank may include a first distribution manifold having a plurality of openings positioned along a lower portion of the water tank for releasing the air into the body of water. In other embodiments, the surfactant column may include a second distribution manifold having a plurality of openings positioned along a lower portion of the surfactant column for releasing the air into the surfactant solution. Distributing the air to be released from the plurality of openings may improve contact between the air and the body of water and/or the surfactant solution and, therefore, increase the amount of the volatile organic compounds that is scrubbed from the air. Similarly, distributing the air to be released into the carbon column may also improve contact and absorption of the volatile organic compounds from the air. Optionally, the opening in the distribution manifolds may include nozzles that prevent backflow of fluid into the distribution manifold and/or reduce the size of bubbles released into the column.

Some embodiments provide a method comprising: drawing air containing volatile organic compounds from a vapor space in a main tank of a vacuum truck that contains wastewater using a liquid ring vacuum pump that is fluidically connected to a vapor space port in the main tank; supplying water from a water tank containing a body of water to the liquid ring vacuum pump to form a water seal that supports operation of the liquid ring vacuum pump; pushing the air and a portion of the water through a discharge port of the liquid ring vacuum pump and into a lower portion of the water tank, wherein the air rises through the body of water to a vapor space in the water tank; directing the air that is in the vapor space of the water tank into a lower portion of a surfactant column containing a surfactant solution, wherein the air rises through the surfactant solution to a vapor space in the surfactant column, and wherein the air is scrubbed to remove the volatile organic compounds from the air as the air rises through the body of water in the water tank and as the air rises through the surfactant solution in the surfactant column; and releasing the scrubbed air into the atmosphere.

In some embodiments, the method may further include or comprise directing the air that is in the vapor space of the surfactant column through a carbon column that absorbs volatile organic compounds from the air as the air passes through the carbon column, wherein the scrubbed air is released into the atmosphere after passing through the carbon column. Although the air may be provided into a lower end of the carbon column and released from the top of the carbon column, the orientation of the carbon column is not critical.

In some embodiments, the method may further include or comprise delivering the air that is directed into the lower portion of the water tank through a first distribution manifold having a plurality of openings positioned along the lower portion of the water tank.

In some embodiments, the method may further include or comprise delivering the air that is directed into the lower portion of the surfactant column through a distribution manifold having a plurality of openings positioned along the lower portion of the surfactant column.

In some embodiments, the method may further include or comprise receiving the wastewater into the main tank of the vacuum truck. Wastewater may be received into the main tank using a separate wastewater pump and tube, where the wastewater pump discharges into the main tank.

The method embodiments may further include any aspect of the scrubber system embodiments disclosed herein, and the scrubber system embodiments may further include any aspect of the method embodiments disclosed herein.

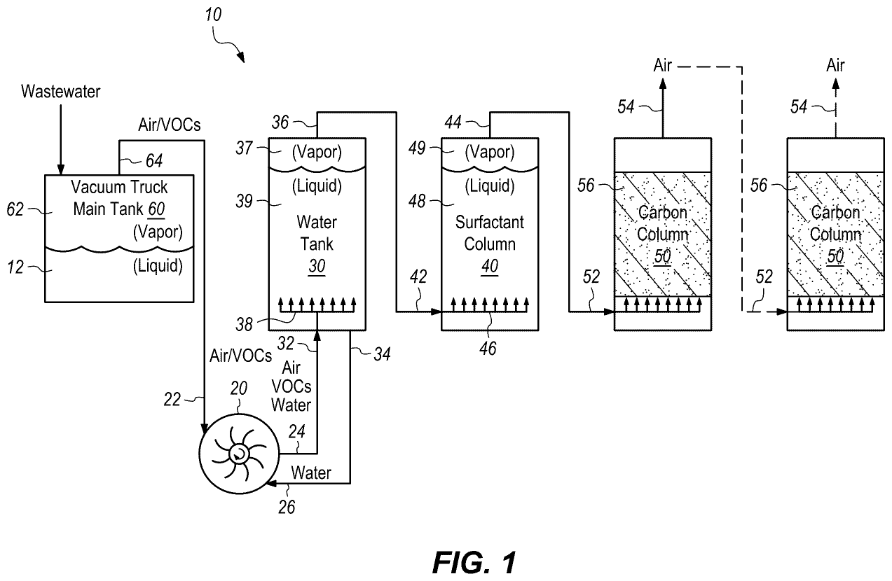

FIG. 1 is a process diagram of a scrubber system 10 according to some embodiments. The scrubber system 10 includes a liquid ring vacuum pump 20, a water tank 30, and a surfactant column 40. The liquid ring vacuum pump 20 has a vacuum inlet port 22, an exhaust outlet port 24, and a water supply port 26. The water tank 30 has an inlet port 32 coupled to the exhaust outlet port 24 of the liquid ring vacuum pump 20, a water return port 34 connected to the water supply port 26 of the liquid ring vacuum pump 20 for supplying water to the liquid ring vacuum pump, and a first overhead vapor port 36. In addition, the surfactant column 40 has an inlet port 42 connected to the overhead vapor port 36 of the water tank 30 and a second overhead vapor port 44.

The scrubber system 10 further includes a carbon column 50 having an inlet port 52 connected to the overhead vapor port 44 of the surfactant tank 40 and an outlet port 54 that opens to the atmosphere. Accordingly, the water tank 30 may provide a first stage scrubber, the surfactant column 40 may provide a second stage scrubber, and the carbon column 50 may provide a third stage scrubber or cleaner. The carbon column 50 includes a dry carbon bed 56 that absorbs volatile organic compounds and, therefore, operates in a different manner than the water tank 30 and surfactant column 40. However, all three stages may remove volatile organic compounds and release air that is cleaner than when the air entered the stage. An optional second carbon column 50 is shown in series with the first carbon column 50 that is connected to the surfactant column 40. Accordingly, the outlet port 54 of the first carbon column 50 does not open to the atmosphere but directs the overhead air and/or vapor to the inlet port of the second carbon column 50. The outlet port 54 of the second carbon column 50 will then open to the atmosphere for the release of the overhead air. The second carbon column 50 may have an identical construction and operation to the first carbon column 50, and the two carbon columns 50 may form the third stage scrubber or cleaner. The connections between the two carbon columns 50 are representative of how two surfactant columns may be installed in series.

In some embodiments, wastewater 12 within a main tank 60 of a vacuum truck (not shown) releases volatile organic compounds into a vapor space 62 in the main tank 60. The liquid ring vacuum pump 20 may then draw air and the volatile organic compounds from the vapor space 62 through the overhead vapor port 64 of the main tank 60 into the vacuum inlet port 22 of the liquid ring vacuum pump 20. Accordingly, the liquid ring vacuum pump 20 forces the air and volatile organic compounds through the water tank 30, the surfactant column 40 and the carbon column 50 in series before the air is released to the atmosphere.

The water tank 30 includes a first distribution manifold 38 having a plurality of openings positioned along a lower portion of the water tank 30 for releasing the air into the body of water 39. Similarly, the surfactant column 40 includes a second distribution manifold 46 having a plurality of openings positioned along a lower portion of the surfactant column 40 for releasing the air into the surfactant solution 48. Distributing the air to be released from the plurality of openings may improve contact between the air and the body of water 39 and/or the surfactant solution 48 and, therefore, increase the amount of the volatile organic compounds that is scrubbed from the air. Similarly, distributing the air to be released into the carbon bed 56 in the carbon column 50 may also improve contact and absorption of the volatile organic compounds from the air.

In one non-limiting example, the main tank 60 may receive wastewater 12 from a domestic wastewater source that emits volatile organic compounds from the wastewater 12 into the vapor space in the main tank 60 above the wastewater 12. The liquid ring vacuum pump 20 draws air containing volatile organic compounds from the vapor space 62 in the main tank that contains wastewater 12. To support operation of the liquid ring vacuum pump 20, water is supplied from the water tank 30 containing the body of water 39 to form a water seal. The liquid ring vacuum pump 20 also pushes the air and a portion of the water through the discharge port 24 into a lower portion of the water tank 30. The air rises through the body of water 39 to a vapor space 37 in the water tank 30. Furthermore, air that is in the vapor space 37 of the water tank 30 is pushed into a lower portion of the surfactant column 40 that contains the surfactant solution 48. The air then rises through the surfactant solution 48 to a vapor space 49 in the surfactant column 40. It should be appreciated that the air is scrubbed to remove the volatile organic compounds from the air as the air rises through the body of water 37 in the water tank 30 and as the air rises through the surfactant solution 49 in the surfactant column 40. Finally, the air that is in the vapor space 49 of the surfactant column 40 is pushed into a lower portion of the carbon column 50 that contains the carbon bed 56. The air is pushed through the carbon bed 56 to absorb volatile organic compounds from the air before releasing the air into the atmosphere.

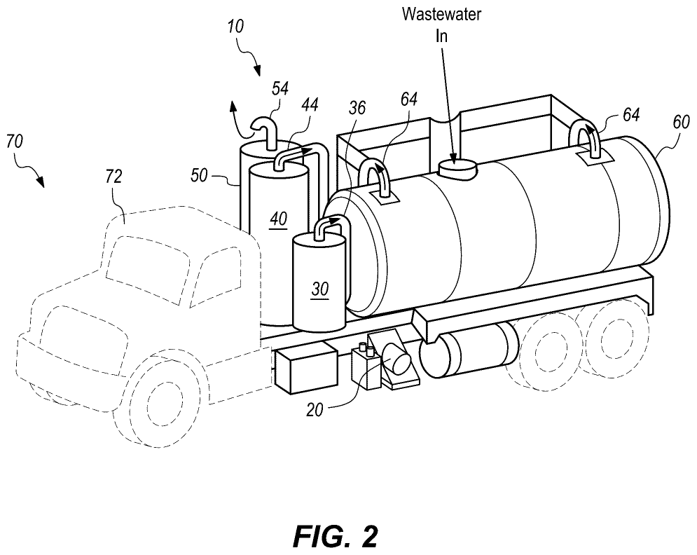

FIG. 2 is a perspective view of a vacuum truck 70 according to some embodiments. The truck that supports the scrubber system 10 may be employed to a variety of locations to collect wastewater from various sources and deliver the collected wastewater to a treatment facility. However, during collection, transport and discharge of the wastewater in the main tank 60, volatile organic compounds in the wastewater may enter into the air within the main tank. The air that contains these volatile organic compounds may be subsequently displaced by additional wastewater being placed into the main tank. Rather than allow the volatile organic compounds in the displaced air to simply enter the atmosphere, the scrubber system 10 removes some or all of the volatile organic compounds from the air prior to releasing the cleaned air into the atmosphere.

The vacuum truck 10 has the basic components of a truck, such as a driver's cab, support frame, engine, transmission and wheels. These basic components of the truck are illustrated in dashed lines, whereas the main tank 60 and the scrubber system 10 are illustrated in solid lines. It should be understood that the scrubber system 10 of FIG. 2 may be implemented consistent with the process diagram of FIG. 1 and any variations described herein. However, in the perspective view of FIG. 2, not all of the connections between components are shown. Still, FIG. 2 is provided to illustrate one physical configuration of the scrubber system 10 on a vacuum truck 70 that includes a main tank 60.

A front end of the vacuum truck 70 may include a driver's cab 72 and a back end of the vacuum truck may support the main tank 60. The liquid ring vacuum pump 20, the water tank 30, the surfactant column 40 and the carbon column 50 are also supported on the vacuum truck 70, such as behind the cab 72 and preferably between the cab 72 and the main tank 60.

This perspective view illustrates the overhead vapor port 64 (two shown) of the main tank 60, the overhead vapor port 36 of the water tank 30, the overhead vapor port 44 of the surfactant tank 40 and an outlet port 54 that opens to the atmosphere. Additional connections between the liquid ring vacuum pump 20, the water tank 30, the surfactant column 40 and the carbon column 50 are not shown (but see FIG. 1).

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A scrubber system, comprising:
a liquid ring vacuum pump having a vacuum inlet port, an exhaust outlet port, and a water supply port;
a water tank having an inlet port coupled to the exhaust outlet port of the liquid ring vacuum pump, a water return port connected to the water supply port of the liquid ring vacuum pump for supplying water to the liquid ring vacuum pump, and a first overhead vapor port; and
a surfactant column having an inlet port connected to the overhead vapor port of the water tank and a second overhead vapor port.

2. The scrubber system of claim 1, further comprising:
a carbon column having an inlet port connected to the overhead vapor port of the surfactant tank and an outlet port that opens to the atmosphere.

3. The scrubber system of claim 2, further comprising:
a vacuum truck having a main tank for receiving wastewater, wherein the main tank has an overhead vapor port coupled to the vacuum inlet port of the liquid ring vacuum pump.

4. The scrubber system of claim 3, wherein the liquid ring vacuum pump, water tank, surfactant column and carbon column are mounted on the vacuum truck.

5. The scrubber system of claim 4, wherein the wastewater releases volatile organic compounds into a vapor space in the main tank, and wherein the liquid ring vacuum pump draws air and the volatile organic compounds from vapor space through the overhead vapor port of the main tank into the vacuum inlet port and forces the air and volatile organic compounds through the surfactant tank and the carbon column in series before the air is released to the atmosphere.

6. The scrubber system of claim 5, wherein the water tank and the surfactant tank each scrub the air to remove volatile organic compounds from the air as the air passes through the water tank and the surfactant tank, and wherein the carbon column absorbs volatile organic compounds from the air prior to releasing the air into the atmosphere.

7. The scrubber system of claim 6, wherein the water tank contains a body of water and the surfactant column contains a surfactant solution.

8. The scrubber system of claim 7, wherein the carbon column contains a bed of activated carbon.

9. The scrubber system of claim 8, wherein the water tank includes a first distribution manifold having a plurality of openings positioned along a lower portion of the water tank for releasing the air into the body of water.

10. The scrubber system of claim 9, wherein the surfactant column includes a second distribution manifold having a plurality of openings positioned along a lower portion of the surfactant column for releasing the air into the surfactant solution.

11. The scrubber system of claim 2, wherein the carbon column contains a bed of activated carbon, and wherein the carbon column includes a distribution manifold having a plurality of openings positioned along a lower portion of the carbon column for releasing the air into the bed of activated carbon.

12. The scrubber system of claim 1, further comprising:
a first carbon column having an inlet port connected to the overhead vapor port of the surfactant tank; and
a second carbon column having an inlet port connected to the outlet port of the first carbon column and an outlet port that opens to the atmosphere, wherein each of the first and second carbon columns contain a bed of activated carbon and a distribution manifold having a plurality of openings positioned along a lower portion of the carbon column for releasing the air into the bed of activated carbon.

13. A method, comprising:
drawing air containing volatile organic compounds from a vapor space in a main tank of a vacuum truck that contains wastewater using a liquid ring vacuum pump that is fluidically connected to the vapor space port in the main tank;
supplying water from a water tank containing a body of water to the liquid ring vacuum pump to form a water seal that supports operation of the liquid ring vacuum pump;
pushing the air and a portion of the water through a discharge port of the liquid ring vacuum pump and into a lower portion of the water tank, wherein the air rises through the body of water to a vapor space in the water tank;
directing the air that is in the vapor space of the water tank into a lower portion of a surfactant column containing a surfactant solution, wherein the air rises through the surfactant solution to a vapor space in the surfactant column, and wherein the air is scrubbed to remove at least a portion of the volatile organic compounds from the air as the air rises through the body of water in the water tank and as the air rises through the surfactant solution in the surfactant column; and
releasing the scrubbed air into the atmosphere.

14. The method of claim 13, further comprising:
directing the air that is in the vapor space of the surfactant column through a carbon column that absorbs volatile organic compounds from the air as the air passes through the carbon column, wherein the scrubbed air is released into the atmosphere after passing through the carbon column.

15. The method of claim 14, further comprising:
delivering the air that is directed into the lower portion of the water tank through a first distribution manifold having a plurality of openings positioned along the lower portion of the surfactant column.

16. The method of claim 15, further comprising:
delivering the air that is directed into the lower portion of the surfactant column through a distribution manifold having a plurality of openings positioned along the lower portion of the surfactant column.

17. The method of claim 13, further comprising:
receiving the wastewater into the main tank of the vacuum truck.

18. The method of claim 17, wherein the wastewater is domestic wastewater.

19. The method of claim 13, wherein the air is scrubbed during collection, transport and discharge of the wastewater.

20. The method of claim 13, wherein at least a portion of the water that is discharged from the liquid ring vacuum pump into the water tank is resupplied back to the liquid ring vacuum pump.
